(19) United States
(12) Patent Application Publication
(10) Pub. No.: US 2005/0262356 A1
(43) Pub. Date: Nov. 24, 2005

(54) Method and system for secure remote access to computer systems and networks

(76) Inventor: Peter Sandiford, Ottawa (CA)

Correspondence Address: DITTHAVONG & CARLSON, P.C., Suite A, 10507 Braddock Rd, Fairfax, VA, 22032, US

(21) Appl. No.: 11/030,007

(22) Filed: Jan. 5, 2005

Related U.S. Application Data
(60) Provisional application No. 60/535,194, filed on Jan. 8, 2004.

(51) Int. Cl. H04K 1/00

(52) U.S. Cl. 713/182

(57) ABSTRACT

A method and system for supporting secure remote access to computer systems and networks, wherein the universe of computer systems and networks to be accessed is partitioned between a plurality of remote sites, each having the ability to grant limited access rights to an external management entity, comprising of the creation of a pending-access request by the external management entity when it determines that access is required to a specific remote site; the initiation of a one-way communication with the external management entity, by an autonomous service located at the specific remote site, at pre-defined times to retrieve the pending-access request; the retrieval of the pending-access request by the specific remote site; the opening of a secure bi-directional communication conduit between the specific remote site and the external management entity; the use of the secure bidirectional communication conduit for remote access to the specific remote site; and the tearing down of the secure bi-directional communication conduit.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF INVENTION

The present invention relates to the field of secure remote-access computing, and more particularly, to a method and system for supporting secure remote access to computer systems and networks through an external management entity.

### BACKGROUND

Secure access to computing resources on a local computing device used to require the physical presence of a user that intends to use the computing device. Requiring the physical presence of a user facilitates a highly secure computing environment, and restricting physical access to a computer is relatively easy. Consequently, requiring a user's physical proximity to a computing device severely limits the options for a system administrator. This constraint is not acceptable in today's scope of systems administration.

A variety of techniques have been used throughout the history of computing to establish secure access to computing resources on a local computing device from a remote computing device. One alternative technique for establishing that is to allow remote access from a remote computing device to a local computing device by way of a private communication medium. The private communication medium might be, for example, a dedicated “hard-wired” communication link. This type of secure remote access environment can be a significant problem if the remote computing device is not readily available to the off-site user at the off-site user's present location.

A considerable advance in respect of these primitive techniques for establishing secure remote access from a remote computing device to a local computing device is to establish remote access by way of an encrypted and/or password-protected MODEM dial-up connection over a public communication medium. However, these systems require the setup and configuration of VPN (Virtual Private Network) appliances or gateways; and they operate by establishing a connection from the outside world into the client's network, which may lead to major security breaches necessitating the re-configuration of firewalls and security policies.

The problem with the above-mentioned techniques is that they each have unique requirements that either severely restrict remote access to local computing devices or severely limit the type and/or configuration of remote computing devices that might otherwise be used to remotely access a local computing device or computing facility.

Thus, a technique for supporting secure remote access to computer systems and networks free of the above-described limitations is needed. The present invention satisfies that need.

### SUMMARY OF THE INVENTION

To overcome the limitations of the prior art described above, the present invention accordingly provides a convenient, easy-to-use method and system for supporting secure remote access to computer systems and networks, wherein the universe of computer systems and networks to be accessed is partitioned between a plurality of remote sites, each having the ability to grant limited access rights to an external management entity, comprising of the creation of a pending-access request by the external management entity when it determines that access is required to a specific remote site; the initiation of a one-way communication with the external management entity, by an autonomous service located at the specific remote site, at pre-defined times to retrieve the pending-access request; the retrieval of the pending-access request by the specific remote site; the opening of a secure bi-directional communication conduit between the specific remote site and the external management entity; the use of the secure bidirectional communication conduit for remote access to the specific remote site; and the tearing down of the secure bidirectional communication conduit.

An advantage of the present invention is that it is easy to configure and setup: it does not require the setup or configuration of VPN gateways or VPN appliances.

Another advantage of the present invention is that it remotely initiates the connection/disconnection of VPN sessions.

A further advantage of the invention is that it establishes a connection from inside the client's network to an outside VPN gateway—in other words, there is no foreign connection into the client's network.

Also, an advantage of the invention is that it provides a more secure connection without requiring the re-configuration of firewalls and security policies.

These and further advantages of the present invention will become apparent from the description of the preferred embodiment which follows.

### BRIEF DESCRIPTION OF THE DRAWINGS

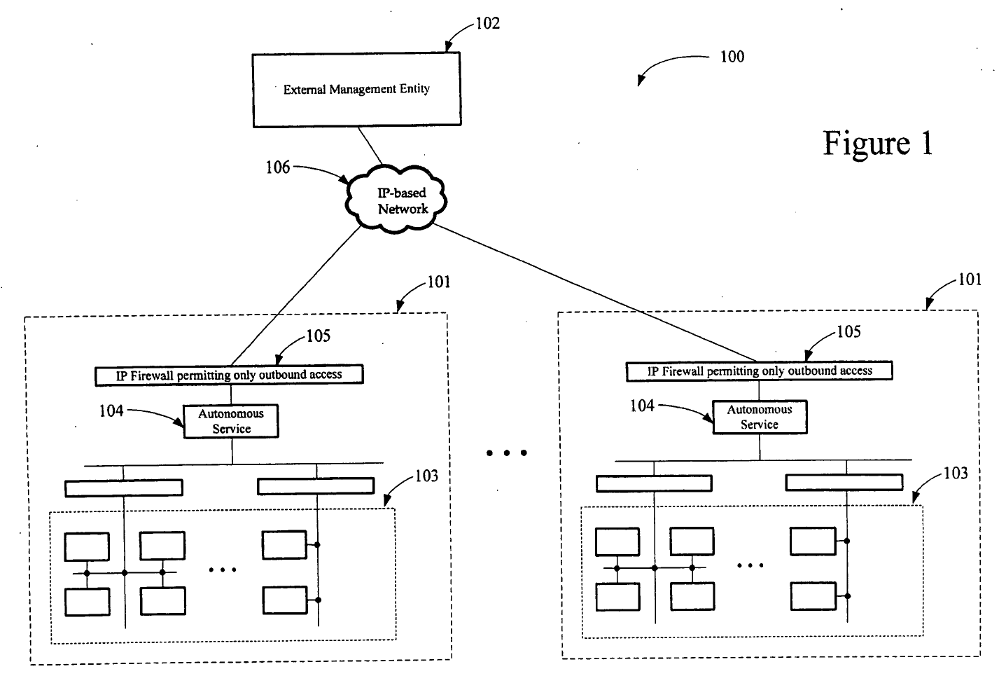

The invention, its organization, construction and operation will be best understood by reference to the following detailed description taken into conjunction with the accompanying drawing (FIGURE 1), which is a block diagram illustrating a plurality of remote sites (101) that have the ability to grant limited access rights to an external management entity (102), whenever such entity requires access to one of the remote sites (101).

(In FIGURE 1, like parts have been given the same reference numerals.)

### DETAILED DESCRIPTION OF THE INVENTION

The invention provides for a method and a system (100) for secure remote access to computer systems and networks (collectively designated by reference numeral 103), based on the principle of a plurality of remote sites (101), each having the ability to grant limited access rights to an external management entity (102), whenever such entity requires access to that remote site (101), wherein the plurality of remote sites (101) contain a plurality of systems and networks (103) some or all of which may be under the remote management of the external management entity (102), said external management entity (102) being able to determine arbitrarily when remote access is required to a remote site (101).

The communication network (106) between the remote site and external management entity is an arbitrary Internet Protocol-based network over which connectivity between the entities may or may not be permanently established. By allowing the connection between the remote sites (101) and the external management entity (102) to be arbitrary, the present invention increases the efficiency of the communication medium (106) between the two.

Further, the communication between the remote sites (101) and the external management entity (102) is one-way, and initiated only by an autonomous service (104) located at the remote site (101). Each remote site (101) also contains an IP firewall (105) that only permits outbound access.

The external management entity (102) creates a pending-access request when it determines that access is required to a specific remote site (101). The autonomous service (104) located at the remote site (101) initiates the one-way communication with the external management entity (102) at a pre-defined time and collects the pending-access request.

In response to the pending-access request, the autonomous service (104) then opens a temporary, secure, bidirectional communications conduit to the external management entity (102), including the use of such security mechanisms as VPN (Virtual Private Network) connectivity, encrypted communication, and access-control restrictions over which end systems and networks (103) may be accessed using the conduit.

The external management entity (102) then uses the temporary bi-directional communications conduit for remote-access purposes. The autonomous service (104) located at the remote site then tears down the temporary bidirectional communications conduit terminating the VPN session.

As a result of the autonomous service (104), the invention provides a way to initiate the connection/disconnection of VPN sessions remotely.

Also, as can be readily concluded, establishing the connection from inside the client's network to an outside VPN gateway, by way of the autonomous service (104) sending the one-way communication to collect the pending-access request, dramatically increases the security of the remote-access connection.

The invention counterbalances the need to setup or configure VPN gateways or VPN appliances, while dealing with the difficulty of connecting to a system that resides inside a client's network, and without the need to re-configure firewalls and security policies.

It is understood that further embodiments of the present invention may be provided for the specific application of SSL and VPN mechanisms as part of the above-described method for securing remote access to computer systems and networks.

Other embodiments and uses of the invention will be apparent to those skilled in the art from consideration of the specification and practice of the invention disclosed herein. The specification and examples should be considered exemplary only and do not limit the intended scope of the invention.

In summary, there is provided a method for supporting secure remote access to computer systems and networks, wherein the universe of computer systems and networks to be accessed is partitioned between a plurality of remote sites, each having the ability to grant limited access rights to an external management entity, comprising the steps of creating a pending-access request by the external management entity when it determines that access is required to a specific remote site; initiating a one-way communication with the external management entity by an autonomous service located at the specific remote site, at pre-defined times to retrieve the pending-access request; retrieving the pending-access request by the specific remote site; opening a secure bidirectional communication conduit between the specific remote site and the external management entity; using the secure bidirectional communication conduit for remote access to the specific remote site; and tearing down the secure bi-directional communication conduit.

Also, there is provided a system for supporting secure remote access to computer systems and networks, wherein the universe of computer systems and networks to be accessed is partitioned between a plurality of remote sites, each having the ability to grant limited access rights to an external management entity, comprising of means to create a pending-access request by the external management entity when it determines that access is required to a specific remote site; means at the specific remote site to initiate a one-way communication with the external management entity in order to retrieve the pending-access request at pre-defined times; means to open a secure bi-directional communication conduit between the specific remote site and the external management entity; means to use the secure bi-directional communication conduit for remote access to the specific remote site; and means to tear down the secure bi-directional communication conduit.

1. A method for supporting secure remote access to computer systems and networks, wherein the universe of computer systems and networks to be accessed is partitioned between a plurality of remote sites, each having the ability to grant limited access rights to an external management entity, comprising the steps:
a) creating a pending-access request by the external management entity when it determines that access is required to a specific remote site;
b) retrieving the pending-access request by the specific remote site;
c) opening a secure bidirectional communication conduit between the specific remote site and the external management entity;
d) using the secure bi-directional communication conduit for remote access to the specific remote site; and
e) tearing down the secure bi-directional communication conduit.

2. The method of claim 1 wherein step (b) further comprises initiating a one-way communication with the external management entity.

3. The method of claim 2 wherein an autonomous service located at the specific remote site initiates the one-way communication.

4. The method of claim 2 wherein the one-way communication is initiated at pre-defined times.

5. The method of claim 1 wherein an autonomous service located at the specific remote site opens the secure bi-directional communication conduit.

6. The method of claim 1 wherein an autonomous service located at the specific remote site tears down the secure bi-directional communication conduit.

7. The method of claim 1 wherein the secure bidirectional communication conduit is established over an IP-based network.

8. The method of claim 1 further comprising the use of VPN connectivity mechanisms.

9. The method of claim 1 further comprising the use of encrypted communication mechanisms.

10. A system for supporting secure remote access to computer systems and networks, wherein the universe of computer systems and networks to be accessed is partitioned between a plurality of remote sites, each having the ability to grant limited access rights to an external management entity, comprising of:
a) means to create a pending-access request by the external management entity when it determines that access is required to a specific remote site;
b) means to retrieve the pending-access request by the specific remote site;
c) means to open a secure bidirectional communication conduit between the specific remote site and the external management entity;
d) means to use the secure bidirectional communication conduit for remote access to the specific remote site; and
e) means to tear down the secure bi-directional communication conduit.

11. The system of claim 10 further comprising means at the specific remote site to initiate a one-way communication with the external management entity at pre-defined times in order to retrieve the pending-access request.

12. The system of claim 10 further comprising means to use VPN connectivity mechanisms.

13. The system of claim 10 further comprising means to use encrypted communication mechanisms.
